(19) United States
(12) Patent Application Publication
(10) Pub. No.: US 2007/0091590 A1
(43) Pub. Date: Apr. 26, 2007

(54) Safety lights for connection to people

(76) Inventor: Baroness Von Czenkow, Charlotte, NC (US)

Correspondence Address: Charles N.J. Ruggiero;Ohlandt, Greeley, Ruggiero & Perle, L.L.P., 10th Floor, One Landmark Square, Stamford, CT, 06901-2682, US

(21) Appl. No.: 11/544,286

(22) Filed: Oct. 6, 2006

Related U.S. Application Data
(60) Provisional application No. 60/725,095, filed on Oct. 11, 2005.

(51) Int. Cl. F21V 21/08

(52) U.S. Cl. 362/103; 362/800; 362/108

(57) ABSTRACT

The personal safety light of the present invention modifies clothing of an adult, teenager, or children. It provides a bright, colored, and perhaps flashing, lights as a safety feature when walking, jogging, in transit, or at any time in public circulation when safety in traffic is a factor.

### RELATED APPLICATION

This application claims priority in U.S. provisional application Ser. No. 60/725,095, filed Oct. 11, 2005.

### BACKGROUND OF THE INVENTION

1. Field of the Invention

The present invention relates to safety lights. More particularly, the present invention relates to personal safety lights that are connectable to a person or a person's clothing and provides an increased visibility of the user to others thereby providing enhanced safety. Even more particularly, the present invention relates to a personal, flashing bright light that is connectable to a person or a person's clothing, to increase visibility of the user to others thereby providing enhanced safety.

2. Description of the Prior Art

A significant problem when a walker, runner or user, specially a small child, moves suddenly, even in a well light area, is for another, such as a driver of a motor vehicle, to determine the immediate position of the user. This immediate visibility problem is particular acute for small children in crowded or heavily trafficked areas, such as parking lots. The small child may move quickly into traffic and the child may be difficult to immediately discern. In such a situation, every second is of the utmost importance. Thus, there is a need to immediately have others, such as a driver of a motor vehicle, to discern that the user, such as a child or runner, has moved towards the driver's vehicle and is perhaps in immediate danger.

### SUMMARY OF THE INVENTION

The present invention provides for the use of personal safety lights on a person, such as a small children.

The present invention further provides that the personal safety light is a flashing type light.

The present invention still further provides that the flashing-type light is a bright flashing light that can be seen in another's visual periphery.

The present invention also provides that the bright flashing light, can be a single bright color, such as red, or a pattern of two or more colors.

The present invention also provides that the bright flashing light is light in weight.

These and other advantages and features of the present invention will be provide by the present invention that includes a personal safety light comprising: a light source having a plurality of LEDs; a body for housing the plurality of LEDs and a power source for activating and powering the light source; and a reflective surface upon which the plurality of LEDs are placed or pierce through, wherein the reflective surface reflects light from the plurality of LEDs. The reflective surface has a portion between each adjacent pair of the plurality of LEDs. When the personal safety light is connected to a wearer and activated, it provides a bright light that can be seen for just about or approximately ½ mile or approximately 2,000 feet. The bright preferably, flashing, is immediately, visually perceptible to another, such a driver, in the driver's visual periphery so that the light provides improved life saving probability especially in busy traffic areas, such as a driver backing out of a parking space in a parking lot.

### BRIEF DESCRIPTION OF THE DRAWINGS

FIG. 1 is a front view of an adult woman having a personal safety light of the present invention thereon.

FIG. 2 is a front view of an adult man having the personal safety light of the present invention thereon.

FIG. 3 is a side view of a runner having the personal safety light of the present invention thereon.

FIG. 4 is a pair of children, one child moving forward, and one child moving away, each having the personal safety light of the present invention thereon.

FIG. 5 is a front view of the light face of the personal safety light of the present invention thereon.

FIG. 6 is the back of the light of FIG. 5.

FIG. 7 is a schematic view of the light of FIG. 5.

FIG. 8 is a strap for use with the personal safety light of the present invention.

FIG. 9 is an “O” ring for use with the personal safety light of the present invention.

### DETAILED DESCRIPTION OF THE PRESENT INVENTION

The present invention is a personal safety light that can be connected or attached to a person or his/her clothing to enhance protection of the user, primarily a pedestrian. This safety light immediately impacts the individual's visibility by half a mile creating an invaluable personal safety light for use by anyone of every age. The person can be an adult, teenager, or child.

The present safety light modifies a person's clothing by connecting or attaching to the clothing or the person him/herself. The flashing lights act as a safety feature when walking, jogging, or in student transit, or at any time in public circulation when safety in traffic is a factor. This invention is of prime importance as the person is most vulnerable in a parking lot, loading area, and in almost every traffic situation.

The light can be connected as a bracelet or arm band, and can be worn attached to a shirt, jacket, belt, hat, shoe or any article of clothing.

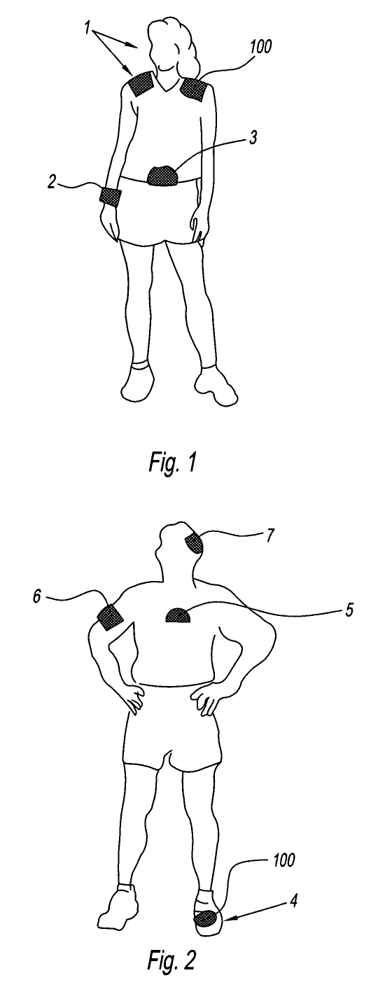

Referring to the drawings and, in particular, FIG. 1, there is provided an adult woman wearing a light of the present invention generally represented by reference numeral 100. The light 100 can be positioned as epaulet 1 or on a wrist 2, or at the belt 3 of the woman. The light 100 can be worn with slacks, skirts, dresses, suits, coat, rainwear according to need and season.

As shown in FIG. 2, the personal safety light 100 can be on shoes 4, at the chest 5 or upper arm of the user, or on a sleeve 6 or a hat 7 of the user.

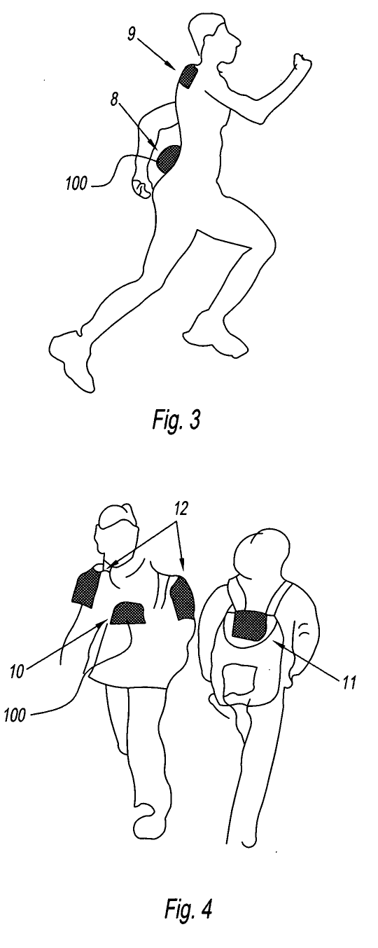

FIG. 3 shows a runner wearing the personal safety light 100 at the back belt line 8. Also, the light 100 can be worn center back on vest or shirt or jacket 9.

FIG. 4 shows the light 100, used on one of its preferred embodiments, namely on a school children. The children have the personal safety light 100 on their chest 10, back pack 11, and/or sleeves 12.

In summary, the light 100 can be placed anywhere on the body or clothing of the wearer in view of the convenient way of connected, discussed below, and because of the lightness in weight and relatively small size of the light 100. Nonetheless, the effectiveness of the light 100 as visual stimuli is significant.

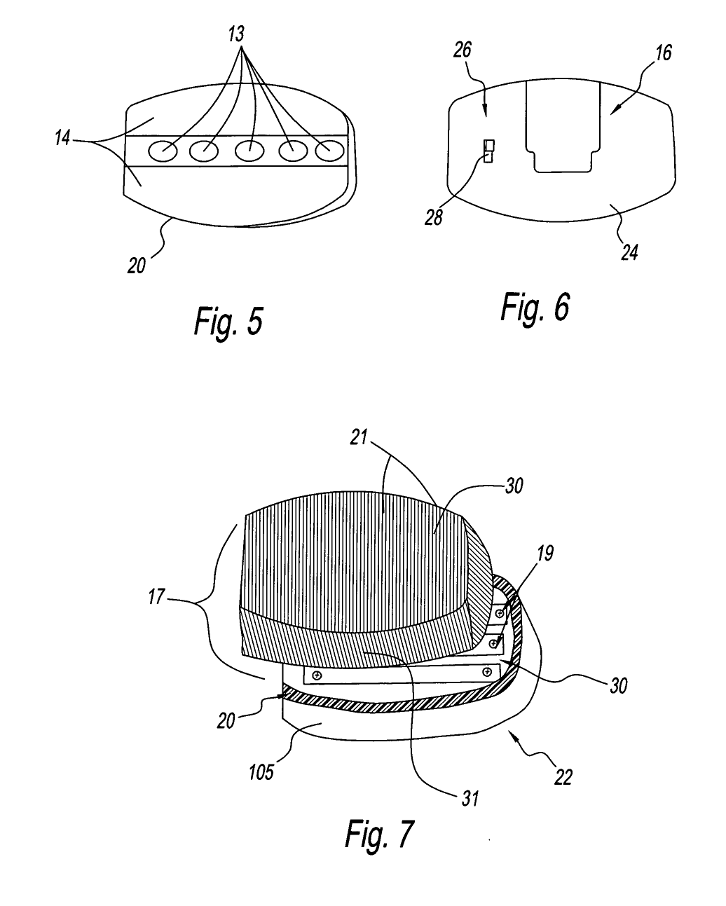

FIG. 5 shows an inside surface of the bottom portion 20 of the body 105 of the light 100. The inside surface is primarily a metallic reflective surface 14 upon which or through which or around which LEDs 13 are positioned.

The light 100 is two or more lights 13. Preferably, light 13 is an LED. More preferably, there are at least three to seven LEDs 13, and they are positioned in a row. More preferably, the number of LEDs is three or five or seven. Most preferably, there are five LEDs. However, the number of LEDs is not limited to a precise number, and the LEDs can be in an amount that run the length of the light 100. Again, the LEDs 13 are preferably in a row, however that can possible be in a random pattern, but spaced from each other.

Each LED 13 is preferably positioned in the center of the reflective surface 14. In the embodiment shown in FIG. 5, the reflective surface 14 is the core or surface of the light 100 and the LEDs 13, preferably five, are separated but surrounded by the reflective surface so that the LEDs have a better reflective effect. In every embodiment, it is preferred that there is some surface 14 between each adjacent pair of LEDs 13 and surface 14 beyond the last LED 13 in a row.

Each LED 13 lasts 100 hours if set on the “continuous” setting and 150 hours if set on the “flashing” setting. The flash setting provides a strobe light. Clearly, the LEDs 13 last between 100 to 150 hours if the settings vary between continuous and flashing. It is found that each light 100 can be seen for about ½ mile or about 2,000 feet.

Referring to FIG. 6, the back 26 of the light 100 preferably has an “on and off” button 28 to preserve the batteries 16 shown in FIG. 7 that powers the light 100. In the body, there is a controller or chip that when the button is activated, activates the power source in one of two modes, namely a continuous or an intermittent or flashing mode. The controller or chip is conventionally known.

The back 26 of the light 100 may have a belt clip 16 that allows for the secure placement of the light on clothing. Preferably, the belt clip 16 is a clip on that will not damage clothing and yet provides a secure connection.

Referring to FIG. 7, the light 100 has a body or case 105 that is preferably at least 2″×3″×2″ wide as shown by reference numeral 17. The body or case 105 opens as shown by reference numeral 30 to provide a compartment for one or more AAA batteries 19. Preferably, the batteries 19 last 150 hours before recharging or change of batteries. The body 105 has a rubber gasket 20 positioned between the top portion 21 and bottom portion 22 of the light body 105 so that the body is airtight. Thus, the light 100 is waterproof and therefore it can float, as well as can be used in wet weather.

The top portion 21 has a top 30 and a wide or tall side 31. Side 31 is about the circumference of the top portion 21 and permits light therethrough. Preferably, the top 30 and sides 31 of the top portion 21 of the body 105 is red. However, the top and sides can be another bright color that denotes or indicates a warning, such as, for example, amber, blue, green or yellow. The bottom portion 22, which holds the batteries and LEDs, can be any color. However, the bottom portion preferably is a transparent smoke grey color.

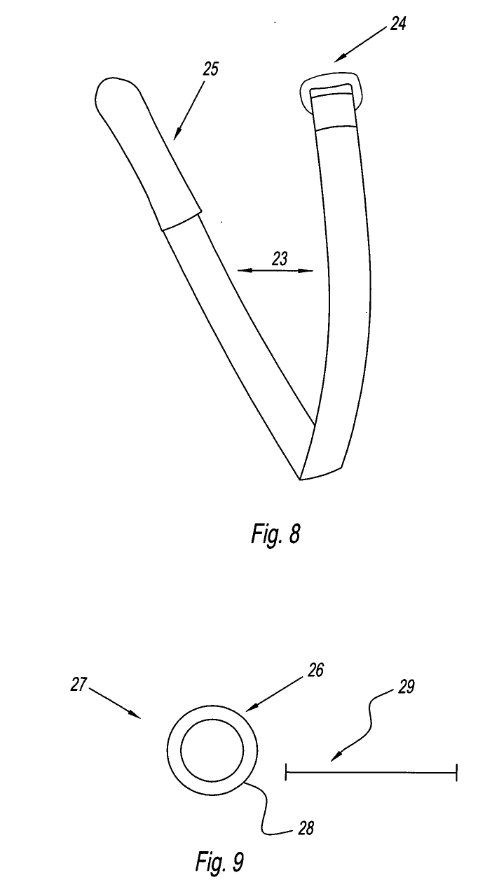

FIG. 8 shows a strap 24 that can be used in the present invention. The strap 24 is preferably about ¾ inch wide by about 14 inches in total length as shown by reference numeral 23. The strap 24 preferably has a plastic loop sewn on one end thereof. Preferably, the strap 24 is made of or has Velcro. In a preferred embodiment, the strap 24 has a 2 inches male velcro weave closure 25 at the other end of the strap. This allows the wearer to slip the strap 24 through the end loop and double back over the light to secure the strap in position on the user and, thus, the light in position on the user.

FIG. 9 shows an “O” ring 26 with a scale measurement 29. The “O” ring 26 preferably is 2 inches in circumference and is available as an attachment option. The “O” ring 26 preferably has a slip opening 28 that flexes open and shut. This allows the belt clip 16 of the light 100 to accept the “O” ring 26.

The belt clip 16 is the standard backing of the light 100, and is used a great majority of the time since it is secure for almost every possible use on clothing. Belt clip 16, as well as strap 24, and “O” ring 26, allow for a multitude of options. High visibility is a critical factor in avoiding traffic accidents involving seniors crossing streets, children in transit to school or on the way home, and any pedestrian navigating through streets. The present personal safety light 100 provides long distance, high visibility.

It is to be understood that the above examples are for illustrative purposes only. Variations to these embodiments can be made and remain within the scope of the present invention.

Wherefore, I claim:

1. A personal safety light comprising:
a light source having a plurality of LEDs;
a body for housing the plurality of LEDs and a power source for activating and powering the light source; and
a reflective surface upon which the plurality of LEDs are placed or pierce through, wherein the reflective surface reflects light from the plurality of LEDs,
wherein the reflective surface has a portion between each adjacent pair of the plurality of LEDs,
wherein when the personal safety light is connected to a wearer and activated, it provides a bright light that can be seen for about ½ mile.

2. The personal safety light of claim 1, further comprising a controller so that the plurality of LEDs provide a continuous light.

3. The personal safety light of claim 1, further comprising a controller so that the plurality of LEDs provide a flashing light.

4. The personal safety light of claim 1, wherein the body has a top portion and a bottom portion that are openable with respect to each other.

5. The personal safety light of claim 1, wherein the bottom portion of the body can hold the power source therein.

6. The personal safety light of claim 1, wherein the top portion of the body has a colored surface through which the LEDs emit light.

7. The personal safety light of claim 6, wherein the colored surface is red so that the light emitted appears to be red.

8. The personal safety light of claim 1, further comprising a belt clip for easy and without damage connecting the personal safety light to clothing of a user.

9. The personal safety light of claim 8, wherein the belt clip is formed or connected to the body of the personal safety light.

10. The personal safety light of claim 1, further comprising a strap for securing the personal safety light to a user.

11. The personal safety light of claim 10, wherein the strap is a velco strap.

12. The personal safety light of claim 1, further comprising an O ring.

13. The personal safety light of claim 13, wherein the O ring has a scale measurement.

14. The personal safety light of claim 13, wherein the O ring has a slip opening that flexes open and shut to connect the O ring to a user.

15. The personal safety light of claim 1, wherein the plurality of LEDs is from three to seven LEDs.

16. The personal safety light of claim 1, wherein the plurality of LEDs are positioned in a row.

17. The personal safety light of claim 1, wherein the plurality of LEDS are positioned in a straight row and in the center of the body.

18. A personal safety light comprising:
a light source having a plurality of LEDs aligned in a row;
a body for housing the LEDs and a power source for activating and powering the light source, wherein the LEDs are positioned in the center portion of the body;
a reflective surface upon which the LEDs are placed or pierce through, wherein the reflective surface reflects light from the LEDs; and
means for connecting the personal safety light to a user;
wherein the reflective surface has a portion between each adjacent pair of the plurality of LEDs,
wherein when the personal safety light is connected to a wearer and activated, it provides a bright light that can be seen for about ½ mile.

19. The personal safety light of claim 18, wherein the connecting means can be one of a belt clip, a strap and an O ring.

20. The personal safety light of claim 18, wherein the connecting means can connect the personal safety light as a bracelet, an arm band, onto a shirt, jacket, belt, hat, back pack, or shoe of the user.
